(19) United States
(12) Patent Application Publication
(10) Pub. No.: US 2018/0216610 A1
(43) Pub. Date: Aug. 2, 2018

(54) DEVICE AND METHOD FOR CONTROLLING TEMPERATURE OF LOW-TEMPERATURE PUMP

(71) Applicant: Korea Aerospace Research Institute, Daejeon (KR)

(72) Inventors: Hyok Jin CHO, Daejeon (KR); Hee Jun SEO, Daejeon (KR); Sung Wook PARK, Daejeon (KR); Guee Won MOON, Daejeon (KR)

(73) Assignee: Korea Aerospace Research Institute, Daejeon (KR)

(21) Appl. No.: 15/746,526

(22) PCT Filed: Apr. 14, 2016
(86) PCT No.: PCT/KR2016/003865

§ 371 Date: Jan. 22, 2018

(30) Foreign Application Priority Data
Jul. 22, 2015 (KR) 10-2015-0103504

(51) Int. Cl. F04B 37/08; B64G 7/00; F04B 39/06; F28D 20/02

(52) U.S. Cl. CPC F04B 37/08; B64G 7/00; B64G 2007/005; F28D 20/028; F04B 39/06

(57) ABSTRACT

Provided is a cryopump enabling the maintaining of a preset temperature during a preset time, even when turned off. The cryopump may comprise: a displacer which adjusts outside temperature by compressing or expanding a refrigerant existing therein; a thermal conduction part which transfers heat outside the cryopump to the refrigerant; and a thermal conduction buffer part which, if the displacer is turned off, absorbs the heat outside that is transferred to the refrigerant, and uses same as energy for changing a phase.

### TECHNICAL FIELD

The present invention relates to a method and apparatus for controlling a temperature of a cryopump and, more particularly, to a cryopump that maintains a set temperature using a phase change material (PCM) and a method thereof.

### BACKGROUND ART

A space environment is a harsh environment in which extreme high and low temperatures are consistently repeated in a high vacuum condition due to solar radiation.

The space environment is different from an environment of the earth. For this reason, a satellite which operates normally on the ground may have an unexpected error or malfunction in the space environment. Thus, preparation for such an error may be required.

In a related art, a cryopump may be used to realize a simulation environment for conducting a thermal vacuum test simulating the space environment. However, vibration occurring due to back-and-forth movement of a displacer in the cryopump may cause an error in an experiment with a subject susceptible for vibration such as satellite optical components.

When a test is conducted using the cryopump turned off to prevent an error that may occur due to the vibration, there is a possibility that an additional error may occur in a vacuum environment of the test such as increases in pressure inside a chamber due to a failure of the cryopump.

### DISCLOSURE OF INVENTION

### Technical Solutions

An aspect of the present invention provides a method and apparatus for maintaining a set temperature to conduct a thermal vacuum simulation experiment while a cryopump is turned off. For example, in the cryopump, a thermal conductive buffer including a phase change material may absorb a heat inside a chamber and use the heat as a phase change energy. Through this, even when an operation of the cryopump is suspended, cryopump may be maintained at the set temperature. Some aspects will be further described as an example but not limited thereto.

According to an aspect of the present invention, there is provided a cryopump including a displacer configured to adjust an outside temperature of a cold head by compressing and expanding a refrigerant included in the cryopump, a thermal conductor configured to transfer an external heat of the cryopump to the refrigerant, and a thermal conductive buffer configured to absorb the external heat transferred to the refrigerant and use the absorbed external heat as a phase change energy when the cryopump is turned off.

The thermal conductive buffer may include a phase change material and the phase change material absorbs the external heat transferred to the refrigerant.

The phase change material may absorb the external heat transferred to the refrigerant and use the absorbed external heat as a phase change energy for changing a phase.

The phase change material may have at least one melting point in a range from 12 to 14 Kelvin temperature (K).

The thermal conductive buffer may be connected to a cold head of the cryopump to absorb the external heat transferred to the refrigerant.

According to another aspect of the present invention, there is also provided a method of maintaining an outside temperature of a cold head of a cryopump by absorbing a heat transferred to a refrigerant and using the absorbed heat as a phase change energy when the cryopump is turned off.

A method of maintaining an inside temperature of a cold head of cryopump may include absorbing, by a thermal conductive buffer, an external heat transferred from an inside of the chamber to a refrigerant when the cryopump is turned off and using the absorbed external heat as a phase change energy of a phase change material included in the thermal conductive buffer.

The phase change material may absorb the external heat transferred to the refrigerant and use the absorbed external heat as a phase change energy for changing a phase.

The phase change material may have at least one melting point in a range from 12 to 14 K.

The method may further include setting the inside temperature of the cold head of cryopump and reducing a vibration transferred to the chamber by turning-off the cryopump when the inside temperature of the cold head is in a predetermined error range of a set temperature.

According to still another aspect of the present invention, there is also provided a method of calculating an amount and types of phase change materials based on a simulation experiment environment including a set temperature.

A method of designing a cryopump to maintain a set temperature may include calculating a change in an amount of heat for maintaining the set temperature during a predetermined period of time and calculating an amount and a type of phase change material to be inserted into the cryopump based on the calculated change in the amount of heat.

The calculating of the amount and the type of phase change material may include determining whether the phase change material has a melting point in a predetermined error range based on the set temperature.

### BRIEF DESCRIPTION OF DRAWINGS

FIG. 1 is a diagram illustrating an example of a cryopump according to an example embodiment.

FIG. 2 is a diagram illustrating an example of a temperature change of a chamber in association with a thermal conductive buffer.

FIG. 3 is a block diagram illustrating a cryopump according to an example embodiment.

FIG. 4 is a flowchart illustrating a method of maintaining an inside temperature of cold head of cryopump according to an example embodiment.

FIG. 5 is a flowchart illustrating a method of designing a cryopump that maintains a set temperature according to an example embodiment.

### BEST MODE FOR CARRYING OUT THE INVENTION

Hereinafter, example embodiments will be described in detail with reference to the accompanying drawings. It should be understood, however, that there is no intent to limit this disclosure to the particular example embodiments disclosed. Like numbers refer to like elements throughout the description of the figures. Terminologies used herein are defined to appropriately describe the example embodiments of the present disclosure and thus may be changed depending on a user, the intent of an operator, or a custom. Accordingly, the terminologies must be defined based on the following overall description of this specification.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

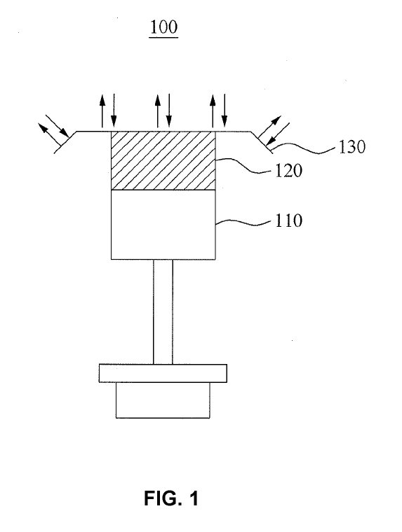

FIG. 1 is a diagram illustrating an example of a cryopump according to an example embodiment. A cryopump 100 may be a device that condenses gas in a cryogenic condition below 120 Kelvin temperature (K) or locks the gas in a condensation to create a vacuum condition. The cryopump 100 may be used widely to obtain a high degree of vacuum in an experiment associated with a spacecraft or a satellite.

The cryopump 100 may include a cold head 110, a thermal conductive buffer 120, and a thermal conductor 130. The cold head 110 may function to cool the cryopump 100 using a refrigerant delivered through a compressor. The cold head 110 may receive a cold refrigerant through a displacer to cool the cryopump 100. The displacer may be configured to compress or expand a refrigerant inside the cryopump 100.

The thermal conductor 130 may transfer an external heat of the cryopump 100 to the refrigerant.

For example, the thermal conductor 130 may be implemented using a metal having a relative high thermal conductivity such as a copper.

The thermal conductive buffer 120 may maintain the cryopump 100 at the same temperature as in an outside of the cryopump 100 even when the cryopump 100 is turned off. The thermal conductive buffer 120 may include a phase change material.

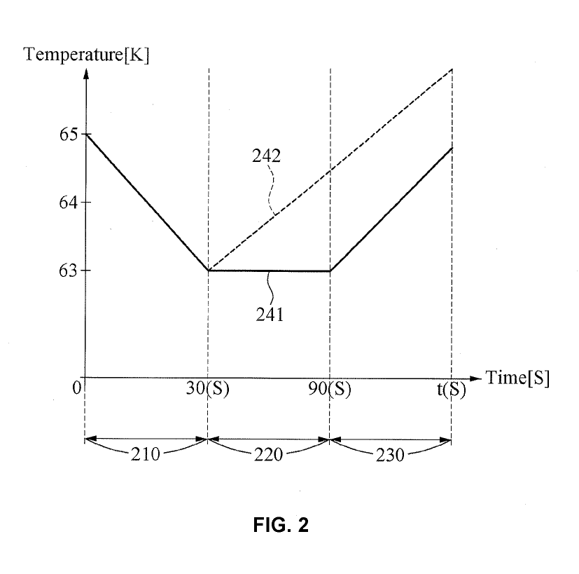

The phase change material included in the thermal conductive buffer 120 may absorb the external heat transferred to the refrigerant of the cold head 110. The absorbed heat may be used as a phase change energy of the phase change material. In the above operation principle, a temperature of a chamber simulating a space environment may be maintained to be approximate to a set temperature while using the cryopump 100 turned off. The operation principle will be further described with reference to FIG. 2.

FIG. 2 is a diagram illustrating an example of a temperature change of a cold head of a cryopump association with a thermal conductive buffer. In this drawing, graphs each show a temperature change of a cryopump cold head n which a simulation experiment is conducted based on a change in time. An X axis represents a time in units of seconds (s) and a Y axis represents a temperature in units of Kelvin temperature (K). In the example of FIG. 2, it is assumed that a set temperature of a simulation space environment is about 63 K.

In a first time interval 210, a cryopump may be turned on to cool a cold head such that an inside temperature of a chamber is equalized to a set temperature. Specifically, in the first time interval 210, the cryopump may use a displacer to compress or expand a refrigerant in the cryopump and reduce an outside temperature. For example, compressed helium gas may be used as the refrigerant.

When the inside temperature of head cold reaches the set temperature, in a second time interval 220, the cryopump may be turned off to conduct an experiment. In the second time interval 220, the cryopump may be turned off to remove micro-vibration that may be transferred to a satellite or its component. A first graph 241 and a second graph 242 may be obtained in the second time interval 220 based on whether a thermal conductive buffer is included in the cryopump.

The first graph 241 may be a time-temperature graph illustrating a case in which a thermal conductive buffer including a phase change material is included in the cryopump. In this case, the inside temperature of the cold head may not increase although the cryopump is turned off and the cooled and compressed refrigerant does not circulate in response to the inside temperature reaching 63 K. This may be because a thermal energy emitted from an inside of the chamber is used to change a phase of the phase change material included in the thermal conductive buffer. In this example, the inside temperature of the cold head may be maintained at the set temperature of 63 K for one minute corresponding to the second time interval, starting from a time of 30 s to a time of 90 s. Also, since the cryopump is turned off during the second time interval 220, the vibration may be maintained at a minimum degree. The foregoing may be an approach that ensures a more realistic environment for various experiments simulating the space environment.

The second graph 242 may be a time-temperature graph of a chamber using a cryopump in a related art. In the second time interval 220, the cryopump may be turned off and an inside temperature of the cold head may increase. A cooled and compressed refrigerant may not additionally move to a cold head of the cryopump, which may lead to an increase in the inside temperature of the chamber. In this example, the inside temperature may not be maintained at the set temperature of 63 K.

In terms of implementing an ideal experimental environment, a trade-off relationship may be established between the set temperature and a low-vibration environment of the cryopump in the related art. To more accurately implement the set temperature, the cryopump may be turned off to remove a vibration unnecessarily occurring in a satellite. Also, when the cryopump for implementing the low-vibration environment is turned off, the refrigerant may not move and the inside temperature of the chamber may increase, which may be an error in a simulating experiment.

Accordingly, by using a thermal conductor including a phase change material, the inside temperature of the cold head may be maintained during a predetermined period of time even when the refrigerant does not move due to the cryopump turned off.

In a third time interval 230, the inside temperature may increase as shown in the first graph 241 and the second graph 242. This may be because all phase change materials present in the thermal conductor are changed in phase and do not absorb the phase change energy. Thus, in a stage of designing an experiment, there may be implemented a configuration of calculating an amount and types of phase change materials in response to a set temperature corresponding to a simulated space environment being input using a computer program or application. The configuration will be further described with reference to the following drawing.

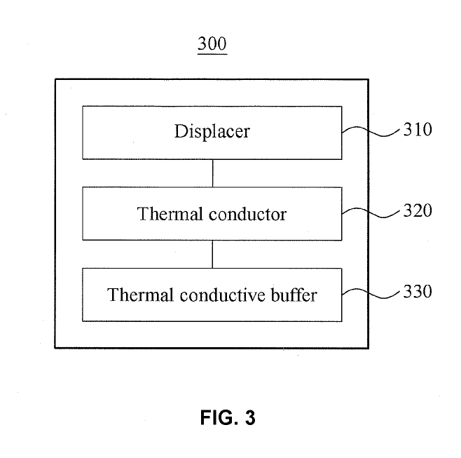

FIG. 3 is a block diagram illustrating a cryopump, according to an example embodiment. A cryopump 300 may control a temperature such that an inside temperature of a cold head is maintained even when a movement of a refrigerant is suspended by a displacer 310. The cryopump 300 may include the displacer 310, a thermal conductor 320, and a thermal conductive buffer 330.

The displacer 310 may adjust an outside temperature of cold head by compressing or expanding a refrigerant included in the cryopump 300. The displacer 310 may supply a compressed refrigerant from a compressor to a cold head of the cryopump 300. The compressed liquid refrigerant may absorb a heat of the chamber through the cold head of the cryopump 300, whereby the chamber is maintained as an ultra-low temperature vacuum environment.

The thermal conductor 320 may absorb an external heat of the cryopump 300 and transfer the external heat to the refrigerant. For example, an outside of the cryopump 300 may be an inside of the chamber in which a simulating experiment associated with a space environment is conducted.

As described above, when the inside temperature of the cold head is approximate to an error range of the set temperature, the thermal conductive buffer 330 may absorb the external heat transferred by the thermal conductor 320 to the refrigerant. The external heat absorbed by the thermal conductive buffer 330 may be used as a phase change energy. The thermal conductive buffer 330 may be connected to the cold head of the cryopump 300 to absorb the external heat of the cryopump 300 transferred to the refrigerant.

The thermal conductive buffer 330 may include a phase change material. The melting point or the phase change energy amount may correspond to a unique attribute of a material. Thus, based on an experiment time or a set temperature at which the simulating experiment is conducted, an amount or types of phase change materials may be determined. The phase change material may absorb the external heat transferred to the refrigerant and use the absorbed heat as a phase change energy for changing a phase from a liquid to a solid.

For example, for the simulating experiment corresponding to the space environment, a material having at least one melting point in a range from 12 K to 14 K may be selected as the phase change material.

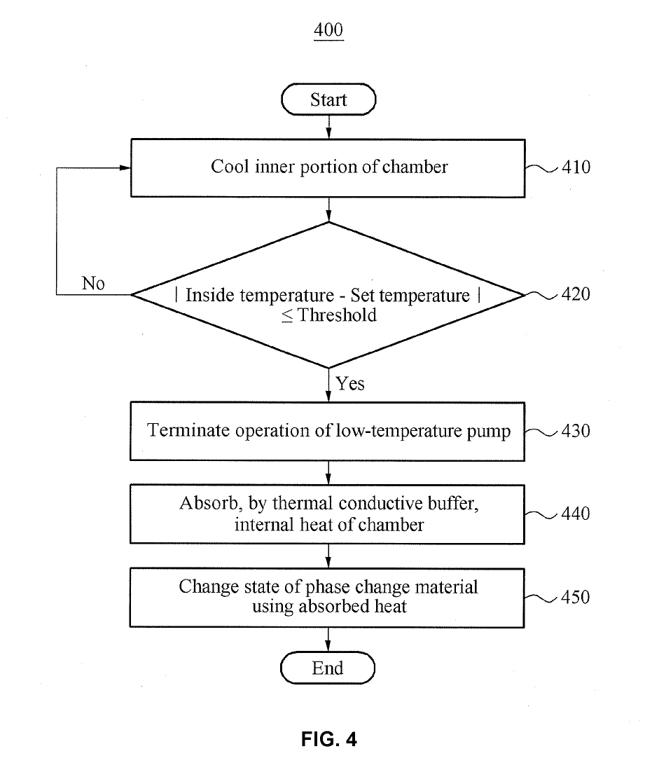

FIG. 4 is a flowchart illustrating a method of maintaining an inside temperature of a cold head of the cryopump according to an example embodiment. A method 400 of maintaining an inside temperature of a chamber using a cryopump may cool an inner portion of a chamber using the cryopump in operation 410, compare a difference between an inside temperature of the cold head and a set temperature to a threshold in operation 420, terminate an operation of the cryopump in operation 430, absorb an internal heat of the chamber using a thermal conductive buffer in operation 440, and change a phase of a phase change material using the absorbed internal heat in operation 450.

In operation 410, a cryopump may cool a cold head of the cryopump. Through a cold head of the cryopump, a hear exchange may occur between gas present in the chamber and the refrigerant of the cryopump. For example, helium may be used as the refrigerant.

In operation 420, a difference between an inside temperature of the cold head and a set temperature for a simulating experiment may be compared to a threshold. The threshold may be set based on accuracy designed for the simulating experiment. In operation 420, a time for cooling the inner portion of the chamber may be determined together with a vibration of a displacer while the cryopump is turned on.

When the difference between the inside temperature and the set temperature is less than or equal to the threshold, operation 430 in which an operation of the cryopump is terminated may be performed. In operation 430, an operation of the cryopump may be terminated, so that vibration is removed. Through this, a user may realize a more precise vacuum low vibration condition. When the difference between the inside temperature of the cold head and the set temperature is greater than the threshold, operation 410 may be performed such that an additional cooling is performed on the inner portion of the cold head.

In operation 440, when the cryopump is turned off, the thermal conductive buffer included in the low-chamber pump may absorb an internal heat of the chamber. In operation 450, a phase change material included in the thermal conductive buffer may change a phase using the absorbed internal heat. Since the heat absorbed from the chamber is used as the phase change energy, the cold head may also be maintained at the set temperature when the cryopump is turned off. Through this, the user may realize a more precise simulating experiment environment.

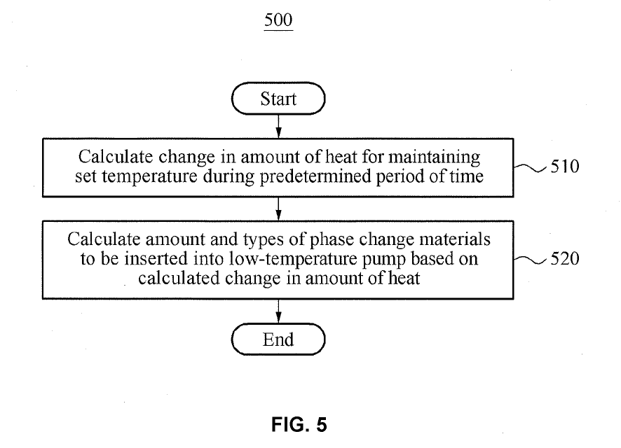

FIG. 5 is a flowchart illustrating a method of designing a cryopump that maintains a set temperature according to an example embodiment. A method 500 of designing a cryopump that maintains a set temperature may calculate a change in heat amount for maintaining the set temperature during a predetermined period of time in operation 510 and calculate an amount and a type of phase change material to be inserted into the cryopump based on the calculated change in heat amount in operation 520.

Operation 510 may be an operation of calculating a change in an amount of heat for maintaining the set temperature during a predetermined period of time. Based on a target of a simulating experiment, a size of a low-pressure chamber, a gas component in the low-pressure chamber, and the number of moles in gas may be differently determined. An amount of heat to be absorbed by a thermal conductive buffer to maintain the set temperature during a unit time sufficient to conduct the simulating experiment may be calculated in operation 510.

Operation 520 may be an operation of calculating an amount and types of phase change materials to be inserted into the cryopump based on the calculated change in the amount of heat. In a simulating experiment conducted during a long period of time, a phase change material included in the thermal conductive buffer may be designed to have a large thermal capacity or the large number of moles. When a simulating experiment is conducted for a relatively short period of time, a phase change material included in the thermal conductive buffer may have a small thermal capacity and the small number of moles. Also, operation 520 may include an operation of determining whether a melting point is included in a predetermined error range based on the set temperature.

The above-described method may be applied to apparatuses. The above-described method may be executed by a pre-distributed computer program or application. Accordingly, a user performing the experiment may obtain an amount and types of phase change materials corresponding to an experiment conducted time and a set temperature as an output when an input value corresponding to a specification of an experiment is input to the computer program or the application.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A cryopump comprising:
a displacer configured to adjust an outside temperature by compressing or expanding a refrigerant included in the cryopump;
a thermal conductor configured to transfer an external heat of the cryopump to the refrigerant; and
a thermal conductive buffer configured to absorb the external heat transferred to the refrigerant and use the absorbed external heat as a phase change energy when the displacer is turned off.

2. The cryopump of claim 1, wherein the thermal conductive buffer includes a phase change material and the phase change material absorbs the external heat transferred to the refrigerant.

3. The cryopump of claim 2, wherein the phase change material absorbs the external heat transferred to the refrigerant and uses the absorbed external heat as a phase change energy for changing a phase.

4. The cryopump of claim 2, wherein the phase change material has at least one melting point in a range from 12 to 14 Kelvin temperature (K).

5. The cryopump of claim 1, wherein the thermal conductive buffer is connected to a cold head of the low-temperature pump to absorb the external heat transferred to the refrigerant.

6. A method of maintaining an inside temperature of a chamber using a cryopump, the method comprising:
absorbing, by a thermal conductive buffer, an external heat transferred from an inside of the chamber to a refrigerant when the cryopump is turned off; and
using the absorbed external heat as a phase change energy of a phase change material included in the thermal conductive buffer.

7. The method of claim 6, wherein the phase change material absorbs the external heat transferred to the refrigerant and uses the absorbed external heat as a phase change energy for changing a phase.

8. The method of claim 6, wherein the phase change material has at least one melting point in a range from 12 to 14 Kelvin temperature (K).

9. The method of claim 6, further comprising:
setting the inside temperature of the cold head using the cryopump; and
reducing a vibration transferred to the chamber by turning-off the cryopump when the inside temperature of the cold head is in a predetermined error range of a set temperature.

10. A method of designing a cryopump to maintain a set temperature, the method comprising:
calculating a change in an amount of heat for maintaining the set temperature during a predetermined period of time; and
calculating an amount and a type of phase change material to be inserted into the cryopump based on the calculated change in the amount of heat.

11. The method of claim 10, wherein the calculating of the amount and the type of phase change material comprises:
determining whether the phase change material has a melting point in a predetermined error range based on the set temperature.
